(19) United States
(12) Patent Application Publication
(10) Pub. No.: US 2017/0000008 A1
(43) Pub. Date: Jan. 5, 2017

(54) TRANSPORT WING ATTACHMENT

(71) Applicant: CNH Industrial America LLC, New Holland, PA (US)

(72) Inventors: Brian J. Anderson, Yorkville, IL (US); Patrick Dinnon, Plainfield, IL (US); Marvin A. Prickel, Homer Glen, IL (US); Michael J. Connors, Lockport, IL (US)

(73) Assignee: CNH Industrial America LLC, New Holland, PA (US)

(21) Appl. No.: 14/755,741

(22) Filed: Jun. 30, 2015

(51) Int. Cl. A01B 73/06; A01B 63/32; A01C 7/08

(52) U.S. Cl. CPC A01B 73/065; A01C 7/08; A01B 63/32

(57) ABSTRACT

An agricultural planter has a chassis with at least one wing section, which is operable to rotate forward about a vertical hinge to a transport configuration and to rotate outward about the vertical hinge to a working configuration. The agricultural planter has a telescoping hitch assembly made of an inner hitch bar and an outer hitch bar in a sliding relationship. A horsehead is attached to the at least one wing section and configured in such a way as to support the at least one wing section when in the transport configuration by resting upon the top of the outer hitch bar of the telescoping hitch assembly.

### BACKGROUND OF THE INVENTION

1. Field of the Invention

The present invention relates to agricultural planters, and, more particularly, to agricultural planters having wings.

2. Description of the Related Art

Agricultural planters are commonly used implements to plant seeds in soil. An agricultural planter can include a chassis that carries one or more storage tanks full of seeds or other particulate that is to be spread on a field for planting, a hitch mechanism that attaches to a tractor or other implement pulled by a tractor, and a tool bar to which row units can be connected so that they are carried by the chassis. The planter can also include a pneumatic system carried by the chassis that supplies pressurized air to transport the seeds or other particulate from the storage tanks to the row units.

Each row unit of the agricultural planter places seeds in the field. Typically, the row units are laterally arranged along a length of the tool bar so that as the planter is pulled across the field, each row unit plants seeds at predefined intervals along the path it is pulled across. To plant seeds, the row units perform four main operations as they are pulled: opening a trench in the soil; placing a seed into the formed trench at appropriate intervals; closing the formed trench to put soil on top of the placed seed; and packing soil on top of the seed to provide desirable soil contact with the placed seed. To open a trench in the soil, a furrowing disc, also called an opening disc, presses into the soil and rotates, dislocating soil as it rotates to form the trench. Once the trench is open, a seed is placed in the trench by a metering device which receives seeds from the main storage tank(s) or a row unit storage tank and typically utilizes a combination of differential air pressure and gravity to place the seed in the trench at predefined intervals along the pulled path so that adjacent seeds in the row are not too close to one another. One or more closing discs carried behind the furrowing disc are pressed into the soil and also rotate as the planter is pulled to replace soil dislocated by the furrowing disc in the trench or dislocate adjacent soil into the trench to cover the seed placed in the trench with soil. Finally, a pressing wheel carried behind the closing disc(s) exerts pressure on the soil covering the seed to press the soil down onto the seed and provide good soil contact with the seed. By having multiple row units working in unison as the planter is pulled across a field, many seeds can be effectively planted in an efficient manner.

Agricultural planters, like other agricultural implements, are often very wide, in order to efficiently perform their function over a large area in a given pass by the implement. In order to accomplish this, and yet to be transportable by road, they are often built to be folded into a transport configuration and unfolded into a working configuration. In order to fold into the transport configuration, often a set of wing sections rotate forward about vertical hinges until they are parallel with a main hitch bar.

What is needed in the art is a way to simply and reliably hold the wing sections in their forward rotated position when in the transport configuration.

### SUMMARY OF THE INVENTION

The present invention provides such a way to simply and reliably hold the wing sections in their forward rotated position when in the transport configuration.

The invention in one form is directed to an agricultural planter having a chassis with at least one wing section, which is operable to rotate forward about a vertical hinge to a transport configuration and to rotate outward about the vertical hinge to a working configuration. The agricultural planter has a telescoping hitch assembly made of an inner hitch bar and an outer hitch bar in a sliding relationship. A horsehead is attached to the at least one wing section and configured in such a way as to support the at least one wing section when in the transport configuration by resting upon the top of the outer hitch bar of the telescoping hitch assembly. The horsehead has a hook portion that partially wraps around the side of the outer hitch bar opposite from the at least one wing section when the at least one wing section is in the transport configuration in order to retain the at least one wing section in the transport configuration.

The invention in another form is directed to a method of providing an agricultural planter that is reconfigurable between a working configuration and a transport configuration, the method including several steps. The first step is providing a chassis having at least one wing section that is operable to rotate forward about a vertical hinge to the transport configuration and to rotate outward about the vertical hinge to the working configuration. The second step is providing a telescoping hitch assembly including an inner hitch bar and an outer hitch bar. The third step is providing a horsehead attached to the at least one wing section. The horsehead is configured to support the at least one wing section when it is in the transport configuration by resting upon the top of the outer hitch bar of the telescoping hitch assembly. The horsehead also has a hook portion that at least partially wraps around the side of the outer hitch bar opposite from its respective at least one wing section when the at least one wing section is in the transport configuration in order to retain the at least one wing section in the transport configuration.

An advantage of the present invention is that when the wing sections of the agricultural planter are folded forward into their transport configuration, the wing sections are hooked onto the outer hitch bar of the telescoping hitch assembly, rather than upon the inner hitch bar. In this way, the advantages of a telescoping hitch assembly are preserved, while providing increased stability and durability by supporting the folded wing sections from the non-extending portion of the telescoping hitch assembly. Thus, the outer hitch bar with its greater section modulus receives the weight of the folded wings, and further stress is not transmitted to the sliding joint between the inner hitch bar and the outer hitch bar of the telescoping hitch assembly.

A further advantage of the present invention is that the weight of the wing sections of the agricultural planter is transferred directly to the top of the outer hitch bar by the horseheads, so that the stress is transmitted evenly over the center axis of the outer hitch bar, as opposed to a configuration where the weight may be carried by a bracket attached to the side of the outer hitch bar, thereby introducing torsional stresses into the outer hitch bar. Such torsional stresses would be of further detriment to the sliding joint between the inner hitch bar and the outer hitch bar of the telescoping hitch assembly. The portions of the horseheads that at least partially wrap around the opposite side of the outer hitch bar from the respective wing sections transmit any force tending to separate the respective wing sections outwardly from the outer hitch bar directly to the side of the outer hitch bar, rather than relying upon any such bracket attached to the side of the outer hitch bar.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is an isometric view of an embodiment of an agricultural planter unfolded in a working configuration according to the present invention;

FIG. 2 is an isometric view of the agricultural planter shown in FIG. 1, folded into a transport configuration;

FIG. 3 is a simplified top view of an agricultural planter, folded into a transport configuration, according to an embodiment of the present invention;

FIG. 4 is a section view of the agricultural planter shown in FIG. 3; and

FIG. 5 is a detail view of the section of the agricultural planter shown in FIG. 4.

Corresponding reference characters indicate corresponding parts throughout the several views. The exemplification set out herein illustrates embodiment of the invention, in one form, and such exemplification is not to be construed as limiting the scope of the invention in any manner.

### DETAILED DESCRIPTION OF THE INVENTION

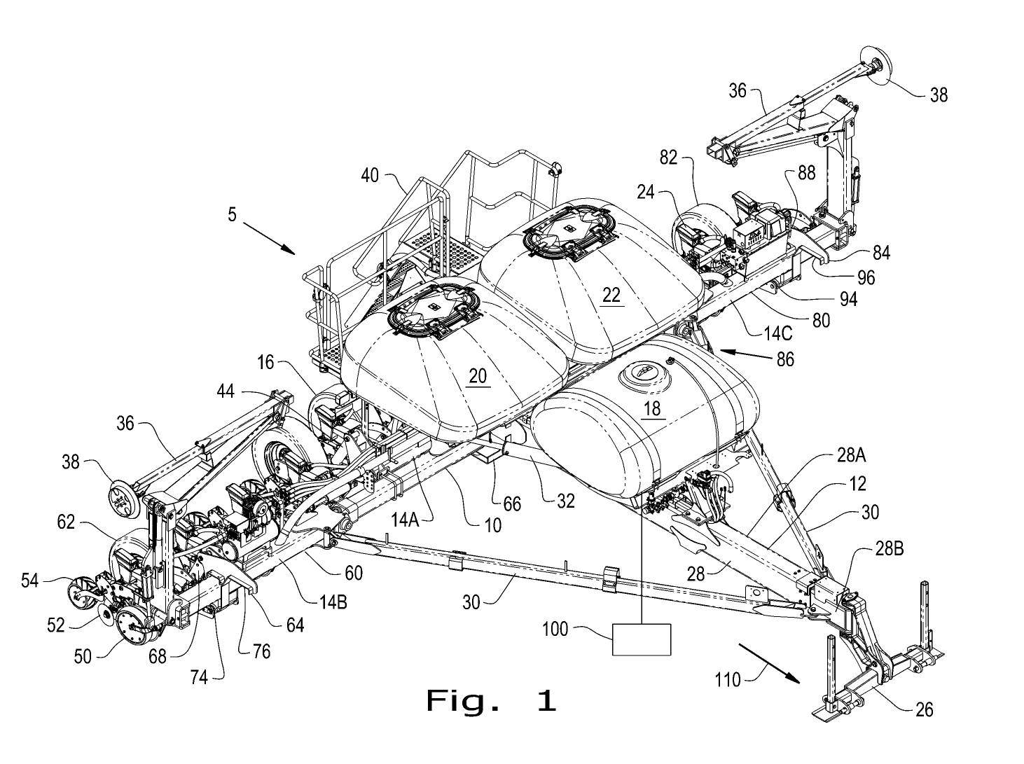

Referring now to the drawings, and more particularly to FIGS. 1-3 there is shown an embodiment of an agricultural planter 5 according to the present invention which generally includes a chassis 10 forming a support structure for components of the planter 5 that can be formed by a hitch assembly 12 at a front of the planter 5 connected to a center section tool bar 14A, main wheels 16 carried by the chassis 10 near the rear of the planter 5, one or more storage tanks 18, 20 and 22 that can be filled with seed or other agriculture material carried by the chassis 10, and a plurality of row units 24 connected to the center section tool bar 14A and arranged laterally across a length of the center section tool bar 14A so that they are carried by the chassis 10. The main wheels 16 are connected to the chassis 10 through main wheel trailing arms 42, which are operable to be raised and lowered using main wheel hydraulic cylinders 44. A right hand wing section 60 including right hand wing section tool bar 14B is pivotally connected to the chassis 10 at right hand wing section vertical hinge 66, and a left hand wing section 80 including left hand wing section tool bar 14C is pivotally connected to the chassis 10 at left hand wing section vertical hinge 86. Further row units 24 are connected to the right hand wing section tool bar 14B and to the left hand wing section tool bar 14C. Each of the row units 24 is provided with furrowing discs 50, closing discs 52, and pressing wheels 54.

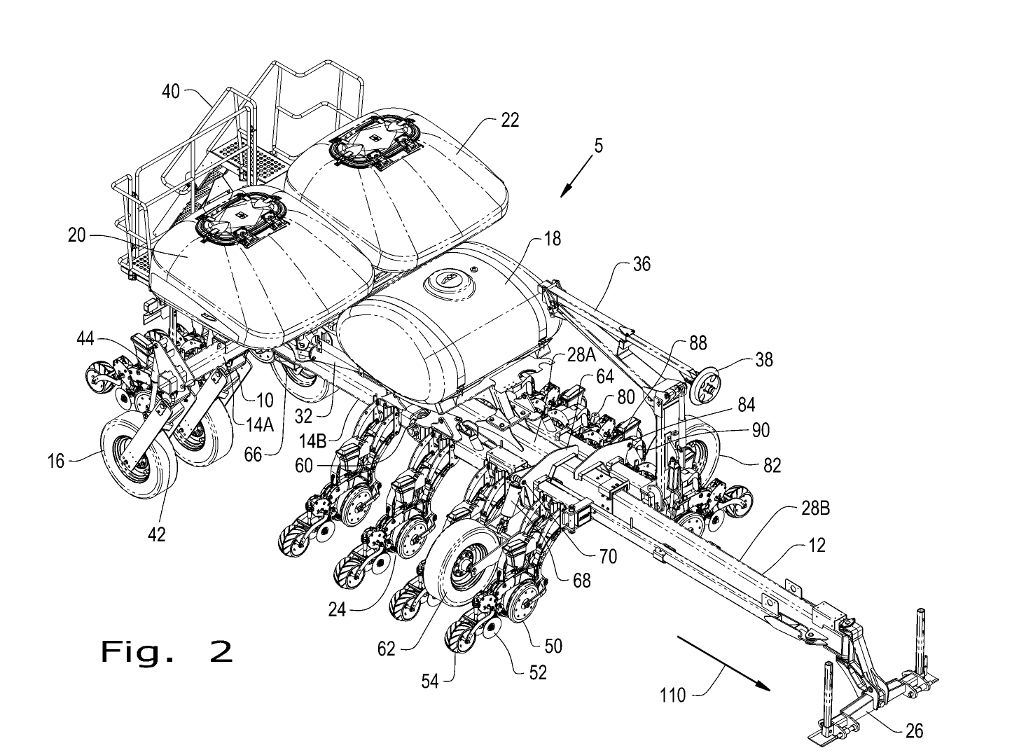

The hitch assembly 12 can include a hitch 26 configured to be connected to a tractor or other agricultural implement (not shown) so that the agricultural planter 5 can be pulled in a forward direction of travel 110. The hitch assembly 12 may further be telescoping, such that it includes an outer hitch bar 28A and an inner hitch bar 28B. The hitch 26 can be integrally formed with or connected to inner hitch bar 28B. The inner hitch bar 28B is connected to the right hand wing section tool bar 14B and to the left hand wing section tool bar 14C by draft tubes 30. One or more folding cylinders 32 are attached to the hitch assembly 12 and to the right hand wing section 60 such that folding cylinders 32 are operable to fold the right hand wing section 60 forward about the right hand wing section vertical hinge 66 upon transitioning from the working configuration to the transport configuration. Similarly, one or more folding cylinders 32 are attached to the hitch assembly 12 and to the left hand wing section 80 such that folding cylinders 32 are operable to fold the left hand wing section 80 forward about the left hand wing section vertical hinge 86 upon transitioning from the working configuration to the transport configuration. When the agricultural planter 5 is thus folded from the working configuration to the transport configuration, the telescoping hitch assembly 12, made of the outer hitch bar 28A and an inner hitch bar 28B, extends as shown in FIG. 2.

As can be seen, the agricultural planter 5 can also have various hydraulic, pneumatic, and electrical lines (unnumbered) throughout to support various cylinders and systems that are included on the agricultural planter 5. A marking device 36 can be connected to each outer end of the wing section tool bars 14B and 14C, and may be extendable so that a marking wheel 38 of the marking device 36 can create a line in the soil as the agricultural planter 5 is pulled along, which helps an operator in positioning the agricultural planter 5 to create subsequent rows. A stair assembly 40 may be mounted to the back of the agricultural planter 5 to allow an operator to access the storage tanks 18, 20 and 22.

The right hand wing section 60 is provided with a right hand wing section horsehead 64, which may be attached to the right hand wing section tool bar 14B, and which hooks over and rests upon the outer hitch bar 28A when the right hand wing section 60 is in its folded position, thereby securely holding the right hand wing section 60 in its folded configuration. Similarly, the left hand wing section 80 is provided with a left hand wing section horsehead 84, which may be attached to the left hand wing section tool bar 14C, and which also hooks over and rests upon the outer hitch bar 28A when the left hand wing section 80 is in its folded position, thereby securely holding the left hand wing section 80 in its folded configuration. Right hand wing section horsehead 64 and left hand wing section horsehead 84 are thusly named due to their shape, which approximates a long tapering shallow inverted hook. Each has a portion that at least partially wraps around and directly attaches to the respective wing section, a wide shoulder portion that serves to carry the weight of the respective wing sections, and a hook portion that actually rests on the top of the outer hitch bar 28A and at least partially wraps around opposite side of the outer hitch bar 28A from the respective wing section. The right hand wing section horsehead 64 and the left hand wing section horsehead 84 may be located at differing positions along the length of respective right and left hand wing sections 60 and 80, so that when in the folded configuration, the right hand wing section horsehead 64 and the left hand wing section horsehead 84 do not interfere with one another.

The right hand wing section 60 has at least one right hand wing section wheel 62, and the left hand wing section 80 has at least one left hand wing section wheel 82. The right hand wing section wheel 62 is connected to the end of a right hand wing section wheel trailing arm 72, which pivots about right hand wing section trailing arm mounting point 74. This right hand wing section trailing arm mounting point 74 may be integrated into the right hand wing section horsehead 64. A right hand wing section wheel lift cylinder 68 is connected to the right hand wing section wheel trailing arm 72 and to a right hand wing section wheel lift cylinder mounting point 70, and is operable to raise and lower the right hand wing section wheel 62. This right hand wing section wheel lift cylinder mounting point 70 may also be integrated into the right hand wing section horsehead 64. Similarly, the left hand wing section wheel 82 is connected to the end of a left hand wing section wheel trailing arm 92, which pivots about left hand wing section trailing arm mounting point 94. This left hand wing section trailing arm mounting point 94 may be integrated into the left hand wing section horsehead 84. A left hand wing section wheel lift cylinder 88 is connected to the left hand wing section wheel trailing arm 92 and to a left hand wing section wheel lift cylinder mounting point 90, and is operable to raise and lower the left hand wing section wheel 82. This left hand wing section wheel lift cylinder mounting point 90 may also be integrated into the left hand wing section horsehead 84. Both right hand wing section horsehead 64 and left hand wing section horsehead 84 may be provided with load distributing plates 76 and 96, respectively, in order to more effectively distribute weight over inner hitch bar 28B.

A control system 100 as shown in FIG. 1 is operably connected to the agricultural planter 5, and more specifically to the folding cylinders 32, to the main wheel hydraulic cylinders 44, to the right hand wing section wheel lift cylinder 68, and to the left hand wing section wheel lift cylinder 88. The control system 100 may further be operably connected to a three point or similar hitch on a tractor (not shown) used to pull the agricultural planter 5, which three point or similar hitch can be raised and lowered. The control system 100 operates to transition the agricultural planter 5 from the working configuration as shown in FIG. 1 to the transport configuration as shown in FIG. 2 by taking the steps of at least partially retracting the main wheel hydraulic cylinders 44, possibly lowering the three point or similar hitch on the tractor, so that the chassis 10 and hitch assembly 12 of the agricultural planter 5 is lower to the ground. Then the control system 100 takes the steps of extending the right hand wing section wheel lift cylinder 68 and the left hand wing section wheel lift cylinder 88, so that the right hand wing section 60 and the left hand wing section 80 are higher from the ground, and then causing the folding cylinders 32 to fold the right hand wing section 60 and the left hand wing section 80 forward to a position parallel to the hitch assembly 12.

The right hand wing section 60 and the left hand wing section 80 fold forward about the right hand wing section vertical hinge 66 and the left hand wing section vertical hinge 86, both of which are sufficiently flexible to allow the relative raising of the right hand wing section 60 and the left hand wing section 80 simultaneous with the lowering of the chassis 10 and hitch assembly 12. In this way, the right hand wing section horsehead 64 and the left hand wing section horsehead 84 pass above the outer hitch bar 28A during the folding procedure. Once the right hand wing section 60 and the left hand wing section 80 are fully folded parallel with the hitch assembly 12, the control system 100 takes the final steps of fully extending the main wheel hydraulic cylinders 44 and possibly raising the three point or similar hitch on the tractor, so that the chassis 10 and the hitch assembly 12 of the agricultural planter 5 is raised higher from the ground, and then retracting the right hand wing section wheel lift cylinder 68 and the left hand wing section wheel lift cylinder 88, so that the right hand wing section 60 and the left hand wing section 80 now rest on the top of the non-telescoping outer hitch bar 28A of the telescoping hitch assembly 12 through the right hand wing section horsehead 64 and the left hand wing section horsehead 84, respectively. The control system 100 continues to retract the right hand wing section wheel lift cylinder 68 and the left hand wing section wheel lift cylinder 88 so that the right hand wing section wheel 62 and the left hand wing section wheel 82 are lifted from the ground with sufficient clearance.

The non-telescoping outer hitch bar 28A of the telescoping hitch assembly 12 is better able to bear the weight and restraining forces of the right hand wing section 60 and the left hand wing section 80 due to its larger section modulus and because, unlike prior art systems wherein such weight was transferred to the sliding inner hitch bar, the weight does not result in further stress on the sliding connection between the outer hitch bar 28A and the inner hitch bar 28B of the telescoping hitch assembly 12. To further facilitate lower stress upon the outer hitch bar 28A, each of the right hand wing section horsehead 64 and the left hand wing section horsehead 84 is provided with load distributing plates 76 and 96, respectively. In this way, a more stable and durable agricultural planter 5 is provided when in the transport configuration, while preserving the advantages of an agricultural planter 5 having a telescoping hitch assembly 12.

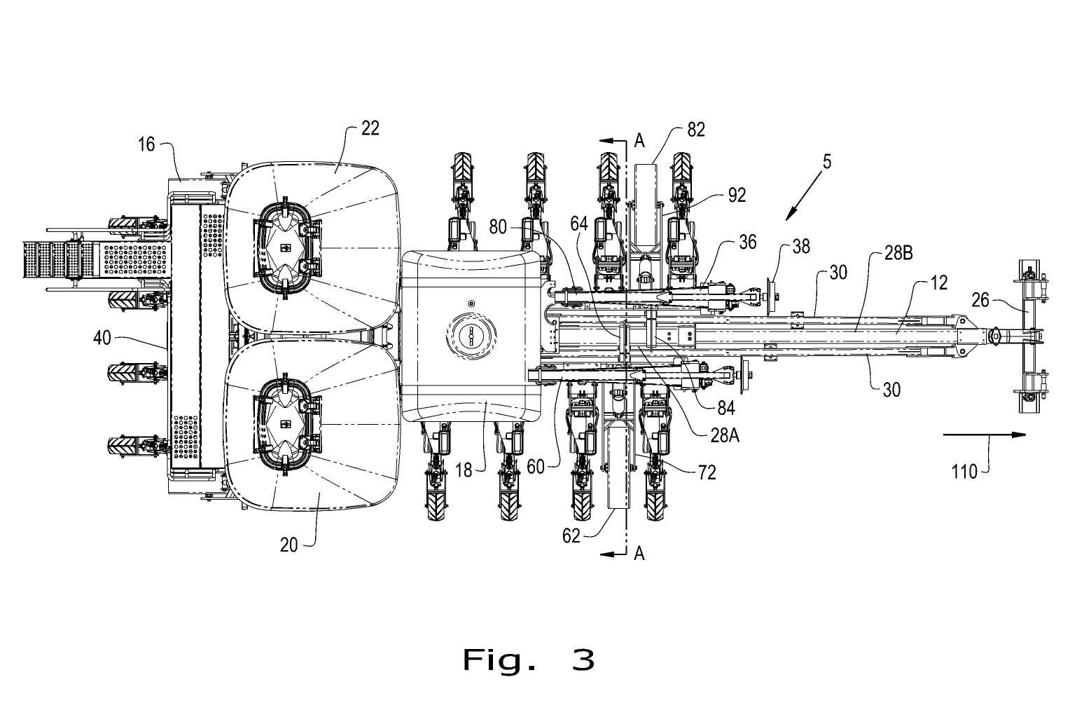

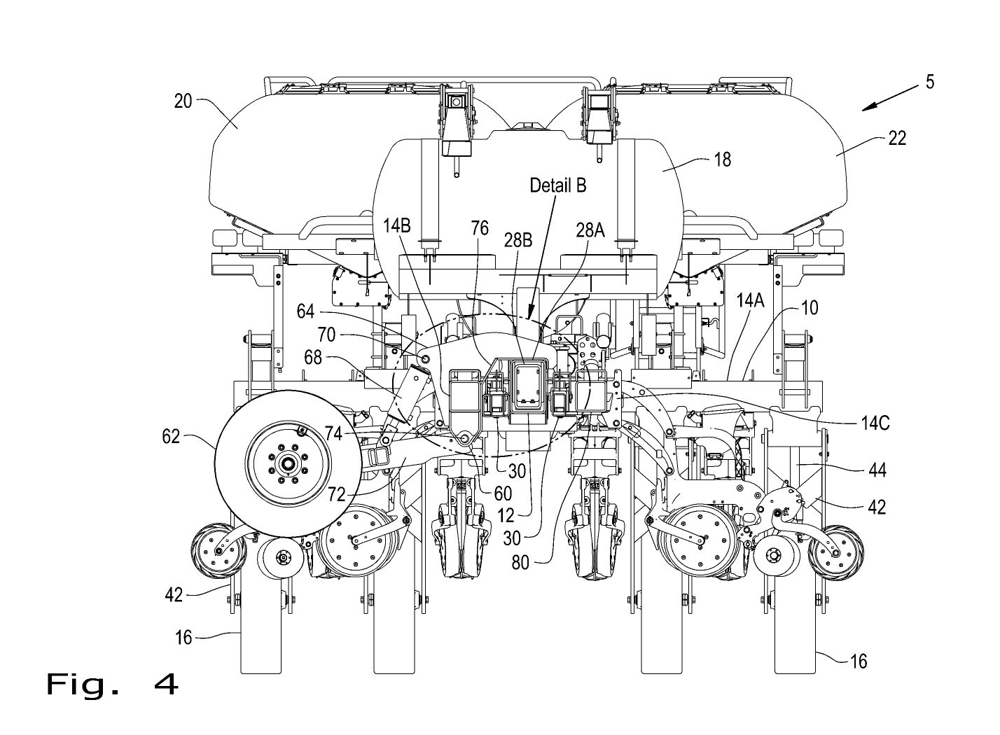

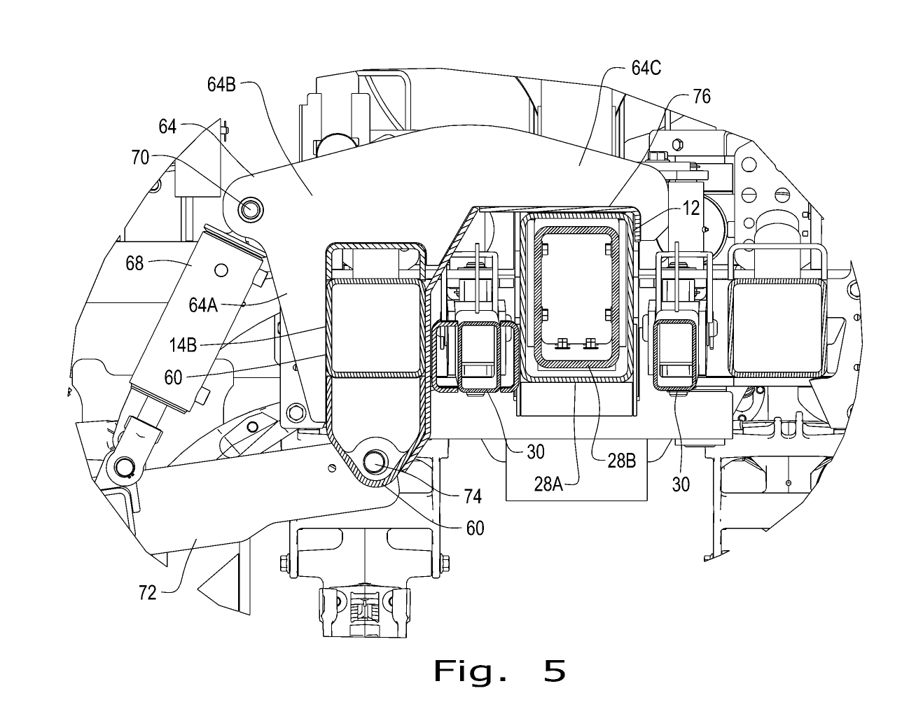

Turning now to FIGS. 4 and 5, further detail is given on the relation between right hand wing section horsehead 64, left hand wing section horsehead 84, and the outer hitch bar 28A of the telescoping hitch assembly 12, when the agricultural planter 5 is in the folded transport configuration. FIG. 4 is a section view taken at section line A-A in FIG. 3. Visible parts of the chassis 10 of the agricultural planter 5 include the telescoping hitch assembly 12, the storage tanks 18, 20 and 22, the center section tool bar 14A, the right hand wing section tool bar 14B of the right hand wing section 60, and the left hand wing section tool bar 14C of the left hand wing section 80, both of which are folded forward into the transport configuration. Main wheels 16 are again connected to the chassis 10 by main wheel trailing arms 42 actuated by main wheel hydraulic cylinders 44. Draft tubes 30 are nested between the right hand wing section tool bar 14B and the telescoping hitch assembly 12, and between the left hand wing section tool bar 14C and the telescoping hitch assembly 12. The telescoping hitch assembly 12 includes outer hitch bar 28A and inner hitch bar 28B, and is assumed to be in its extended configuration in FIGS. 4 and 5. Right hand wing section horsehead 64 and left hand wing section horsehead 84 are configured to reach over draft tubes 30 when resting on the top of outer hitch bar 28A.

FIG. 5 is a detail view of FIG. 4, and shows with greater clarity how the right hand wing section tool bar 14B of right hand wing section 60 rests upon the top of the outer hitch bar 28A of telescoping hitch assembly 12 by way of right hand wing section horsehead 64. Each wing section horsehead 64 and 84 is again provided with a portion that at least partially wraps around and directly attaches to the respective wing section, represented here as horsehead attachment portion 64A, a wide shoulder portion that serves to carry the weight of the respective wing sections 60 and 80, represented here as horsehead shoulder portion 64B, and a hook portion that actually rests on the top of the outer hitch bar 28A and at least partially wraps around opposite side of the outer hitch bar 28A from the respective wing sections 60 and 80, represented here as horsehead hook portion 64C.

In this way, the weight of the respective wing sections 60 and 80 is transferred to the top of the outer hitch bar 28A, directly over its center axis. Further, any force tending to separate the respective wing section 60 and 80 outwardly from the outer hitch bar 28A is transmitted directly to the side of the outer hitch bar 28A opposite to the respective wing section 60 and 80, so that the full section modulus is available to resist such separating force. In addition to providing this support, the right hand wing section horsehead 64 may also provide right hand wing section trailing arm mounting point 74 to which the right hand wing section trailing arm 72 is connected, and right hand wing section wheel lift cylinder mounting point 70 to which the right hand wing section wheel lift cylinder 68 is connected. In this way, actuation of right hand wing section wheel 62 is provided for. Load distribution plate 76 again distributes the weight of right hand wing section 60 over a larger area of the outer hitch bar 28A for lower stress.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An agricultural planter, comprising:
a chassis having at least one wing section, said at least one wing section being operable to rotate forward about a vertical hinge to a transport configuration and to rotate outward about said vertical hinge to a working configuration;
a telescoping hitch assembly including an inner hitch bar and an outer hitch bar; and
a horsehead attached to said at least one wing section and configured to support said at least one wing section when said at least one wing section is in said transport configuration by resting upon the top of said outer hitch bar of said telescoping hitch assembly, said horsehead having a hook portion that at least partially wraps around the side of said outer hitch bar opposite from said at least one wing section when said at least one wing section is in said transport configuration in order to retain said at least one wing section in said transport configuration.

2. The agricultural planter of claim 1, wherein:
said chassis is further provided with a center section tool bar and said at least one wing section is further provided with a wing section tool bar; and
said horsehead is further attached to said wing section tool bar of said at least one wing section.

3. The agricultural planter of claim 1, wherein:
said at least one wing section being further provided with at least one wing section wheel, said at least one wing section wheel being connected to said at least one wing section through a trailing arm, said trailing arm being actuated by a wing section wheel hydraulic cylinder; and
said horsehead having a trailing arm mounting point to which said trailing arm is connected and a cylinder mounting point to which said wing section wheel hydraulic cylinder is connected.

4. The agricultural planter of claim 1, wherein:
at least one draft tube connected to said at least one wing section and to said inner hitch bar of said telescoping hitch assembly, said draft tube describing a diagonal between said at least one wing section and said telescoping hitch assembly when said telescoping hitch assembly is retracted and said at least one wing section is rotated outward about said vertical hinge to said working configuration, said draft tube being nested in between said at least one wing section and said telescoping hitch assembly when said telescoping hitch assembly is extended and said at least one wing section is rotated forward about said vertical hinge to said transport configuration; and
said horsehead being adapted to reach over said at least one draft tube when resting upon the top of said outer hitch bar of said telescoping hitch assembly.

5. The agricultural planter of claim 1, wherein:
said horsehead being further provided with a load distributing plate.

6. The agricultural planter of claim 1, further comprising:
at least one main wheel connected to said chassis through a main wheel trailing arm actuated by a main wheel hydraulic cylinder, said main wheel hydraulic cylinder operable to raise and lower said chassis by extending or retracting said main wheel hydraulic cylinder, respectively;
at least one wing section wheel connected to said at least one wing section through a wing wheel trailing arm actuated by a wing wheel hydraulic cylinder, said wing wheel hydraulic cylinder operable to raise and lower said at least one wing section by extending or retracting said wing wheel hydraulic cylinder, respectively; and
at least one folding cylinder connected between said chassis and said at least one wing section, said at least one folding cylinder operable to cause said at least one wing section to rotate forward about said vertical hinge to said transport configuration and to rotate outward about said vertical hinge to said working configuration.

7. The agricultural planter of claim 6, further comprising:
a control system connected to said main wheel hydraulic cylinder, to said wing wheel hydraulic cylinder, and to said at least one folding cylinder;
said control system operable when transitioning said agricultural planter from said working configuration to said transport configuration to take the steps of:
placing said chassis in a partially raised position using said main wheel hydraulic cylinder;
raising said at least one wing section by fully extending said wing wheel hydraulic cylinder so that said horsehead clears said outer hitch of said telescoping hitch assembly;
causing said at least one folding cylinder to rotate said at least one wing section forward;
fully raising said chassis by fully extending said main wheel hydraulic cylinder;
lowering said at least one wing section by retracting said wing wheel hydraulic cylinder so that said horsehead rests on said outer hitch of said telescoping hitch assembly and so that said at least one wing section wheel is raised from the ground.

8. The agricultural planter of claim 7, wherein:
said control system further connected to an actuator of a hitch of a tractor used to pull said agricultural planter;
said control system further operable when transitioning said agricultural planter from said working configuration to said transport configuration to take the additional steps of:
lowering said hitch using said actuator of said hitch when placing said chassis in said partially raised position using said main wheel hydraulic cylinder; and
raising said hitch using said actuator of said hitch when fully raising said chassis by fully extending said main wheel hydraulic cylinder.

9. The agricultural planter of claim 1, wherein:
said at least one wing section further comprises a left hand wing section and a right hand wing section, and said horsehead further comprises a left hand horsehead attached to said left hand wing section and a right hand horsehead attached to said right hand wing section.

10. The agricultural planter of claim 9, wherein:
said left hand horsehead and said right hand horsehead being located at different positions along the length of said left hand wing section and said right hand wing section, respectively.

11. A method of providing an agricultural planter reconfigurable between a working configuration and a transport configuration, the method comprising the steps of:
providing a chassis having at least one wing section, said at least one wing section being operable to rotate forward about a vertical hinge to the transport configuration and to rotate outward about said vertical hinge to the working configuration;
providing a telescoping hitch assembly including an inner hitch bar and an outer hitch bar; and
providing a horsehead attached to said at least one wing section and configured to support said at least one wing section when said at least one wing section is in the transport configuration by resting upon the top of said outer hitch bar of said telescoping hitch assembly, said horsehead having a hook portion that at least partially wraps around the side of said outer hitch bar opposite from said at least one wing section when said at least one wing section is in said transport configuration in order to retain said at least one wing section in said transport configuration.

12. The method of claim 11, further comprising the steps of:
providing at least one main wheel connected to said chassis through a main wheel trailing arm actuated by a main wheel hydraulic cylinder, said main wheel hydraulic cylinder operable to raise and lower said chassis by extending or retracting said main wheel hydraulic cylinder, respectively;
providing at least one wing section wheel connected to said at least one wing section through a wing wheel trailing arm actuated by a wing wheel hydraulic cylinder, said wing wheel hydraulic cylinder operable to raise and lower said at least one wing section by extending or retracting said wing wheel hydraulic cylinder, respectively; and
providing at least one folding cylinder connected between said chassis and said at least one wing section, said at least one folding cylinder operable to cause said at least one wing section to rotate forward about said vertical hinge to said transport configuration and to rotate outward about said vertical hinge to said working configuration.

13. The method of claim 12, further comprising the steps of:
providing a control system connected to said main wheel hydraulic cylinder, to said wing wheel hydraulic cylinder, and to said at least one folding cylinder;
said control system operable when transitioning said agricultural planter from said working configuration to said transport configuration to take the steps of:
placing said chassis in a partially raised position using said main wheel hydraulic cylinder;
raising said at least one wing section by fully extending said wing wheel hydraulic cylinder so that said horsehead clears said outer hitch of said telescoping hitch assembly;
causing said at least one folding cylinder to rotate said at least one wing section forward;
fully raising said chassis by fully extending said main wheel hydraulic cylinder;
lowering said at least one wing section by retracting said wing wheel hydraulic cylinder so that said horsehead rests on the top of said outer hitch of said telescoping hitch assembly and so that said at least one wing section wheel is raised from the ground.

14. The method of claim 12, wherein:
said horsehead having a wing wheel trailing arm mounting point to which said wing wheel trailing arm is connected and a wing wheel hydraulic cylinder mounting point to which said wing wheel hydraulic cylinder is connected.

15. The method of claim 11, wherein:
said at least one wing section further comprises a left hand wing section and a right hand wing section, and said horsehead further comprises a left hand horsehead attached to said left hand wing section and a right hand horsehead attached to said right hand wing section.

16. The method of claim 15, wherein:
said left hand horsehead and said right hand horsehead being located at different positions along the length of said left hand wing section and said right hand wing section, respectively.
